(19) United States
(12) Patent Application Publication
(10) Pub. No.: US 2019/0227002 A1
(43) Pub. Date: Jul. 25, 2019

(54) APPARATUS AND METHODS FOR INSPECTING DAMAGE INTENSITY

(71) Applicant: Corning incorporated, Corning, NY (US)

(72) Inventors: Evan James Bittner, Corning, NY (US); David John Brockway, Bellefonte, PA (US); Christine Cecala, Corning, NY (US); Heather Bossard Decker, Arkport, NY (US); Shandon Dee Hart, Elmira, NY (US); Eric Louis Null, Corning, NY (US)

(21) Appl. No.: 16/254,804

(22) Filed: Jan. 23, 2019

Related U.S. Application Data
(60) Provisional application No. 62/621,267, filed on Jan. 24, 2018.
(60) Provisional application No. 62/686,880, filed on Jun. 19, 2018.

(51) Int. Cl. G01N 21/958; G01N 21/88

(52) U.S. Cl. CPC G01N 21/958; G01N 2201/02; G01N 2201/127; G01N 21/8851

(57) ABSTRACT

An inspection apparatus including a light source, a sample holding stage, an image capture device, positioned to receive light from the light source after the light has interacted with a sample on the sample holding stage, and a damage metric. The damage metric includes two or more damage levels, and is a function of light in a test image. Further, the damage metric may correlate to visual observation so that an inspection apparatus may mimic how users of devices will perceive damage to the devices. The damage metric may be adjusted to account for different damage types, for example, abrasion and scratch damage.

### CROSS-REFERENCE TO RELATED APPLICATIONS

This application claims the benefit of priority of U.S. Provisional Application Ser. No. 62/621,267 filed on Jan. 24, 2018 and U.S. Provisional Application Ser. No. 62/686,880 filed on Jun. 19, 2018 the contents of which are relied upon and incorporated herein by reference in their entirety as if fully set forth below.

### BACKGROUND

### Field

The present disclosure relates generally to apparatus and methods for inspecting damage intensity and, more particularly, to apparatus and methods for inspecting damage intensity of surface damage in electronic devices.

### Technical Background

The screens in handheld electronic devices are subject to damage during use from contact with a variety of hard objects and surfaces either as wear over time, or during single contact events. One method to minimize the appearance of surface damage involves application of transparent hard coatings to the glass surface. In order to compare the damage resistance of hard coatings, bare glass, and transparent bulk materials it is desirable to generate surface damage in a repeatable manner and to quantify the resulting surface damage. Although damage introduction in a repeatable manner can readily be done, the apparatus and methods for repeatably quantifying the surface damage has been less than desirable. Currently samples are compared visually, though lighting conditions, observer eyesight angles, and training factor heavily into an already subjective comparison. With visual inspection alone there is no record of the sample appearance at the time of evaluation beyond the assigned rating of 1 to 5, where 1 indicates very few or very shallow scratches that are mostly invisible to the naked eye and 5 indicates that the sample is very badly damaged and has increased haze in the damaged region. Given the nature of the visual evaluation, there is variability between observers and even within a given observer's ratings for a sample set. Accordingly, there is a need for improved inspection apparatus and methods for quantifying surface damage.

### SUMMARY

The inspection apparatus and methods described herein enable imaging and quantification of surface damage intensity in bare and coated materials that were subjected to controlled damage testing (for example Taber Abrasion and Garnet Scratch), or to other damage introduction as in-field use. Further, the present apparatus and methods, including the images collected, can be used to quickly identify and prioritize high performing processes and materials and enable repeatable, unbiased categorization of samples; they can also be used for quality control purposes.

The inspection apparatus and methods described herein eliminate the subjective measurement by consistently lighting the sample for image capture and calculating a damage metric value of a specified region of interest within the damaged area. This metric value is evaluated in different ways for different types of abrasion damage; e.g. the abrasion damage metric is used for evaluating samples that have undergone abrasion damage, for example Taber Abrasion, while the scratch damage metric is used to numerically evaluate samples that have been subjected to single pass scratch testing, for example Garnet Scratch with garnet sandpaper; however, this inspection apparatus and methods are not limited to these specific metrics, as damage is directly proportional to the intensity of scattered light. Additionally, visual ranking of the calibration samples is taken into account so that the images and measurements directly correlate to a human's visual interpretation of the induced damage, without the variability in traditional human ranking systems.

More particularly, the present disclosure describes the use of a light source to illuminate samples that have surface damage in the form of a damage track and the subsequent calculation of a damage metric for a region of interest (ROI) within the damage track. The damage track may be a wear track (for example, produced by cyclic contact events with abrasive material, for example but not limited to a Taber Abrasion Test) or scratching (for example produced by a single pass contact event, for example a Garnet Scratch Test). The calculated values may be used to repeatedly and reproducibly categorize the samples in a consistent manner and facilitate identification of high performance processes and materials. The apparatus and methods described herein also may be used for quality control in a production environment, or may be used to quantify damage done during use of a device so as to assist in analyzing the failure mode in device, for example a field-return device (that is a device that has been damaged by a user and returned to the device maker). A device may be, for example, an electronic device having a display, (for example an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), and/or appliance articles).

Additionally the apparatus and methods described herein may be used to systematically collect and compare images of samples which have undergone a variety of damage resistance tests (not limited to wear tracks or scratching created through a controlled damage test set up). An example of a damage resistance test that has been applied to samples which were imaged in this fashion is a tumble test, wherein a sample is put into a container with objects (for example, keys, lipstick, fasteners, coins, writing instruments) that would be found in a typical user's hand bag or pocket, and the container is rotated and/or shaken so that the objects randomly come into contact with the sample and cause random damage, as they would when a device is in the possession and use of an end user.

Further the apparatus and methods described herein may be used to image and quantify damage on intact electronic devices that have been subjected to controlled damage testing, that have been put through other damage resistance testing as described above, or that are field-return devices.

The accompanying drawings are included to provide a further understanding of the principles described, and are incorporated in and constitute a part of this specification. The drawings illustrate one or more embodiment(s), and together with the description serve to explain, by way of example, principles and operation of those embodiments. It is to be understood that various features disclosed in this specification and in the drawings can be used in any and all combinations. By way of non-limiting example the various features may be combined with one another as set forth in the following embodiments:

### Embodiment 1

An inspection apparatus comprising:

a light source;

a sample holding stage;

an image capture device, positioned to receive light from the light source after the light has interacted with a sample on the sample holding stage;

a damage metric comprising two or more damage levels, wherein the damage metric is a function of light in a test image and correlates to visual observation, wherein the test image comprises test light from a test light source after the test light has interacted with a test sample.

### Embodiment 2

The apparatus of Embodiment 1, wherein the light source is a ring light source positioned on the same side of the sample holding stage as is the image capture device.

### Embodiment 3

The apparatus of Embodiment 1, wherein the light source is a first line-light disposed adjacent to the sample holding stage.

### Embodiment 4

The apparatus of Embodiment 3, further including a second line-light disposed adjacent to the sample stage on a side of the sample stage opposite the first line-light.

### Embodiment 5

The apparatus of Embodiment 1, further comprising a sample holding portion in the sample holding stage, and a light-absorbing background material, wherein the light-absorbing background material is disposed on a side of the sample holding portion that is opposite that on which the image capture device is located.

### Embodiment 6

The apparatus of Embodiment 5, wherein the light-absorbing background material is black flocking and the light source is an line-light.

### Embodiment 7

The apparatus of Embodiment 5, wherein the light-absorbing background material is light-absorbing adhesive foil, and the light source is a ring light source.

### Embodiment 8

The apparatus of any one of Embodiments 5-7, wherein the light-absorbing background material is disposed on the sample holding stage.

### Embodiment 9

The apparatus of Embodiment 1, wherein the damage metric is

ln [maximum(mean intensity adjusted,1)], wherein

mean intensity adjusted=mean intensity in a scratched ROI−mean intensity in a non-damaged area, wherein the scratched ROI is a pixel area centered within an intended damage track, and the non-damaged area is outside of the intended damage track.

### Embodiment 10

The apparatus of Embodiment 9, further comprising a sample disposed on the sample stage, wherein the intended damage track includes a wear track produced by a plurality of contact abrasion cycles.

### Embodiment 11

The apparatus of Embodiment 9, or Embodiment 10, wherein when a calibration sample is measured three times without moving the calibration sample, the three measured values of damage metric have a standard deviation of ≤0.023, wherein the calibration sample comprises glass abraded for 500 cycles with a Taber Linear Abraser having CS-17 abradant under a load of 350 g.

### Embodiment 12

The apparatus of Embodiment 1, wherein the damage metric is

ln {maximum [(% pixels with a light intensity value of greater than a threshold value and that are in a scratched ROI)*((mean intensity of pixels with a light intensity of greater than the threshold value in the scratched ROI)−(mean intensity of a non-damaged ROI)),1]},

wherein the scratched ROI is a pixel area within a static area at the beginning of an intended damage track, the non-damaged ROI is outside the intended damage track, and wherein the threshold value is one that is above mean intensity in the scratched ROI and is chosen to filter out light from non-damaged regions that are both within the scratched ROI and within the intended damage track.

### Embodiment 13

The apparatus of Embodiment 12, further comprising a sample disposed on the sample stage, wherein the intended damage track consists of a scratch produced by a single pass contact event.

### Embodiment 14

The apparatus of Embodiment 12 or 13, wherein to calculate the % pixels having a light intensity value of greater than the threshold value, and the mean intensity of those pixels, only consecutive pixels together having a predetermined length or more are utilized, wherein the predetermined length extends in the direction of the longitudinal axis of the intended damage track and is set to filter out false positive values from contamination.

### Embodiment 15

The apparatus of any one of Embodiments 12-14, wherein when twelve samples are measured by each of three different operators, each at four different times, the data set of 144 measured values of damage metric has a standard deviation of ≤0.13.

### Embodiment 16

The apparatus of any one of Embodiments 9-15, wherein the intended damage track is located on a surface of the sample.

### Embodiment 17

A method of calibrating an inspection apparatus for a desired damage type comprising:

obtaining samples having the highest damage and the lowest damage from a sample set of visually ranked samples having the desired damage type;

measuring damage metric values for the samples with the inspection apparatus of any one of Embodiments 1-16, using a selected image capture device exposure, image capture device gain, and/or illumination intensity of the light source;

comparing the measured damage metric values with the visual rankings from corresponding samples;

adjusting at least one of image capture device exposure, image capture device gain, and illumination intensity of the light source; and

repeating the comparing and adjusting so that the measured damage metric values correspond with the visual rankings of corresponding samples.

### Embodiment 18

The method of Embodiment 17, further comprising:

performing a pairs comparison of a set of calibration samples by visual ranking to assign damage levels to each calibration sample;

measuring damage metric values for the set of calibration samples; and

comparing the visually assigned damage levels with the damage metric values for corresponding calibration samples.

### Embodiment 19

An inspection method comprising:

directing light from a light source toward a sample;

capturing with an image capture device an image of light from the light source after the light has interacted with the sample;

analyzing the captured image according to a damage metric comprising two or more damage levels, wherein the damage metric is a function of light in a test image and correlates to visual observation, wherein the test image comprises test light from a test light source after the test light has interacted with the test sample,

assigning a damage level to the captured image.

### Embodiment 20

The method of Embodiment 19, wherein directing light comprises directing light from a ring light source positioned on the same side of the sample as is the image capture.

### Embodiment 21

The method of Embodiment 19, wherein the directing comprises directing light from a first line-light optically coupled to an edge of the sample.

### Embodiment 22

The method of Embodiment 21, wherein the directing further comprises directing light from a second line-light optically coupled to a sample edge on a side of the sample opposite the first line-light.

### Embodiment 23

The method of Embodiment 21 or 22, wherein the sample includes an intended damage track extending along a first axis, the first line-light extends along a second axis, and the second line-light extends along a third axis, and further wherein the first axis is substantially parallel to the second and/or third axis.

### Embodiment 24

The method of Embodiment 19, further comprising absorbing light with a background material, wherein the background material is disposed on a side of the sample that is opposite that on which the image capture is performed.

### Embodiment 25

The method of Embodiment 24, wherein the background material is black flocking and the light source is a line-light.

### Embodiment 26

The method of Embodiment 24, wherein the light-absorbing background material is light-absorbing adhesive foil, and the light source is a ring light source.

### Embodiment 27

The method of Embodiment 19, wherein the damage metric is

ln [maximum(mean intensity adjusted,1)],

wherein mean intensity adjusted=mean intensity in a scratched ROI−mean intensity in a non-damaged ROI, wherein the scratched ROI is a pixel area centered within an intended damage track, and the non-damaged ROI is outside the intended damage track.

### Embodiment 28

The method of Embodiment 27, wherein the intended damage track includes a wear track produced by a plurality of contact abrasion cycles.

### Embodiment 29

The method of Embodiment 19, wherein the damage metric is

ln {maximum [(% pixels with a light intensity value of greater than a threshold value and that are in a scratched ROI)*((mean intensity of pixels with a light intensity value of greater than the threshold value and that are in the scratched ROI)−(mean intensity of a non-damaged ROI)),1]},

wherein the scratched ROI is a pixel area within a static area at the beginning of an intended damage track, the non-damaged ROI is outside the intended damage track, and wherein the threshold value is one that is above mean intensity in the scratched ROI and is chosen to filter out light from non-damaged regions that are both within the scratched ROI and within the intended damage track.

### Embodiment 30

The method of Embodiment 29, wherein the intended damage track consists of a scratch produced by a single pass contact event.

### Embodiment 31

The method of Embodiment 29 or Embodiment 30, wherein to calculate the % pixels with a light intensity value of greater than the threshold value, and the mean intensity of those pixels, only consecutive pixels together having a predetermined length or more are utilized, wherein the predetermined length extends in the direction of the longitudinal axis of the intended damage track and is set to filter out false positive values from contamination.

### Embodiment 32

The method of any one of Embodiments 27-31, wherein the intended damage track is located on a surface of the sample.

The embodiments, and the features of those embodiments, as discussed herein are exemplary and can be provided alone or in any combination with any one or more features of other embodiments provided herein without departing from the scope of the disclosure. Moreover, it is to be understood that both the foregoing general description and the following detailed description present embodiments of the disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description, serve to explain the principles and operations thereof.

### BRIEF DESCRIPTION OF THE DRAWINGS

FIG. 1 is a schematic view of an inspection apparatus according to some embodiments.

FIG. 2 is a schematic plan view of a sample according to some embodiments.

FIG. 3 is a schematic top view of a sample, including portions of the inspection apparatus, according to some embodiments.

FIG. 4 is a schematic top view of portions of the inspection apparatus according to some embodiments.

FIG. 5 is a schematic view of an image captured by an image capture device according to some embodiments.

FIGS. 6A-E include images of samples having variously induced intended damage tracks (using Taber Abrasion as shown on top, and Garnet Scratch as shown on bottom) and having correspondingly different damage levels, wherein FIG. 6A shows a Damage Level of 1, FIG. 6B shows a Damage Level of 2, FIG. 6C shows a Damage Level of 3, FIG. 6D shows a Damage Level of 4, and FIG. 6E shows a Damage Level of 5.

FIG. 7 is a graph of measured Taber Abrasion damage metrics along the y-axis versus visual average pairs comparison ratios along the x-axis, for the same sample set.

FIG. 8 includes images of samples having different static areas, profiles of pixel intensity across horizontal bands of the images, and histograms of pixel intensities of the images.

FIG. 9 is a graph of measured Garnet Scratch damage metrics along the y-axis versus visual average pairs comparison ratios along the x-axis, for the same sample set.

### DETAILED DESCRIPTION

In the following detailed description, for purposes of explanation and not limitation, example embodiments disclosing specific details are set forth to provide a thorough understanding of various principles and aspects. However, it will be apparent to one having ordinary skill in the art, having had the benefit of the present disclosure, that the claimed subject matter may be practiced in other embodiments that depart from the specific details disclosed herein. Moreover, descriptions of well-known devices, methods and materials may be omitted so as not to obscure the description of various principles set forth herein. Finally, wherever applicable, like reference numerals refer to like elements.

Methods and apparatus will now be described more fully hereinafter with reference to the accompanying drawings in which exemplary embodiments of the disclosure are shown. Whenever possible, the same reference numerals are used throughout the drawings to refer to the same or like parts. However, this disclosure may be embodied in many different forms and should not be construed as limited to the embodiments set forth herein.

Description of the Apparatus

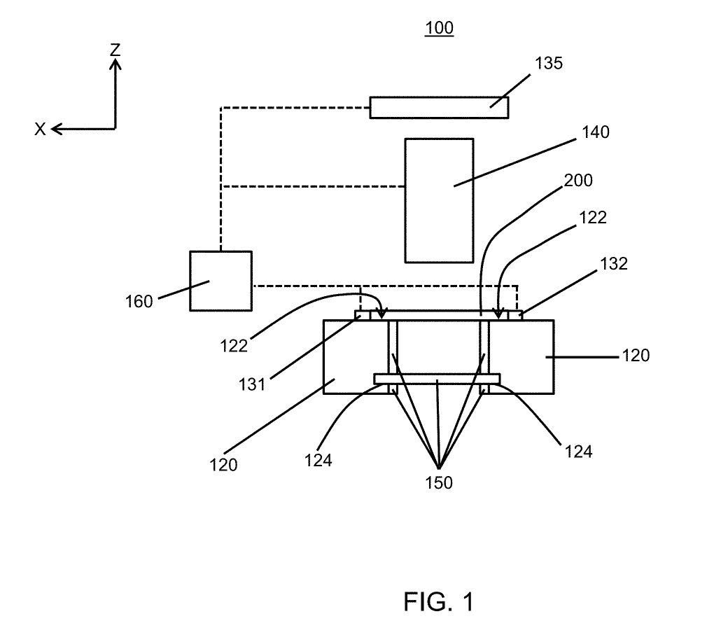

An example inspection apparatus 100 will now be described with reference to FIG. 1. As schematically shown in FIG. 1, the inspection apparatus 100 includes a sample holding stage 120, a light source, an image capture device 140, light-absorbing background material 150, and a controller 160.

The sample holding stage 120 includes a sample-holding portion 122, and a slot 124. The sample holding portion 122 is a flat surface that supports a sample 200 for inspection. Although the sample holding portion 122 is shown as a flat surface, instead it could be a slot, similar to slot 124, within the sample holding stage 120 itself, or other shaped surface for holding a sample. Slot 124 may be used for holding further parts, for example, light-absorbing background material 150 as shown. The sample holding stage 120 is mounted to a base (not shown) so that it may be moved in X, Y, and Z-directions to align the sample 200 within the view of the image capture device 140. In alternative embodiments, the sample holding stage 120 may include other types of motion to accommodate 2.5D and/or 3D cover glass or other shaped articles, wherein it would be desirable to position the surface of interest roughly normal to the direction of view of the image capture device 140. In such alternative embodiments, it would also be desirable to be able to adjust the light source (either position or type) to provide sufficient light to the sample on the sample holding stage 120.

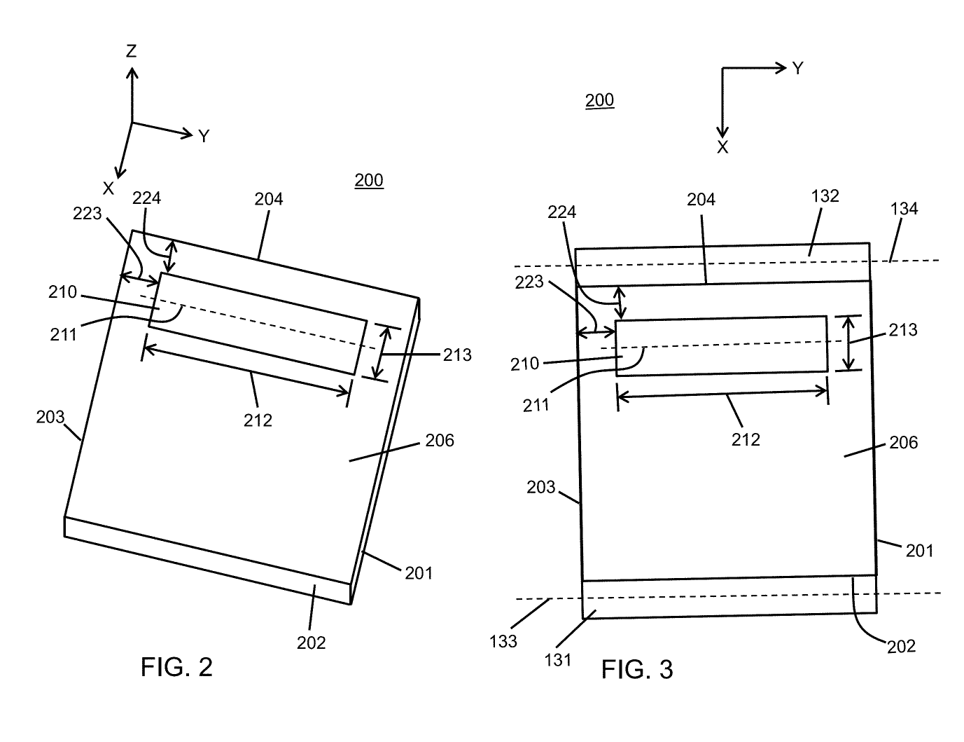

As shown in FIG. 2, the sample 200 includes edges 201, 202, 203, 204, and a surface 206 on which an intended damage track 210 is located. The intended damage track 210 is an area on the surface 206 that has been subject to an event that would likely induce damage. The intended damage track 210 may be intentionally produced on the sample 200 (as when the sample and any coating thereon are being tested for durability), or may be produced in the field when a device (wherein the sample is a part thereof) interacts with its environment. In the latter case, it may be beneficial to analyze the damage for improving the robustness of the device. The event may be a contact event, for example, cyclic abrasion cycles with an abradant, or may be a single contact event that is likely to cause scratching. When the intended damage track 210 is intentionally produced on the sample 200, it is formed along a longitudinal axis 211, over a length 212 and width 213. Further, the intended damage track is produced so as to have one of its corners set a distance 223 from edge 203 and a distance 224 from edge 204. Accordingly, during testing of the sample, the intended damage track 210 may be located and observed by the inspection apparatus 100.

Returning to FIG. 1, the light source may include one or more line-lights 131, 132, and/or a ring light 135. In alternative embodiments, not shown, a point source, or multiple point sources (for example, fiber optic illuminators with lenses, or LED light sources) may be used. For example, 2.5D and 3D cover glass samples (not integrated into a device, but as transparent samples) may be illuminated by using formable LED strips that conform to the curved edge to provide the illumination.

As shown in FIGS. 1 and 3, a first line-light 131 (extending along an axis 133) is optically coupled to edge 202, whereas a second line-light 132 (extending along an axis 134) is optically coupled to edge 204. This configuration, wherein the axes 133, 134 are on parallel edges of the sample, and extend in a direction parallel to axis 211, is beneficial for analyzing samples having an intentionally produced intended damage track 210. When the sample includes more randomly produced damage, the line-lights 131, 132 alternatively may be disposed so that axes 133, 134 extend along adjacent edges (for example 201 and 202, or 202 and 203, or 203 and 204, or 204 and 201) of the sample 200; this configuration may be useful for analyzing damage done in a tumble test, or in a field return analysis, for example. In some embodiments, the line-lights 131, 132 may be beneficial when the sample is a substrate having edges that are accessible. For example, line-lights 131, 132 may be part SK91190048 (or QF5048) from Dolan Jenner, Feasterville, Pa. In some situations, the line-lights 131, 132 may be beneficial in providing an increased amount of light to the sample, which may make it easier to visualize and categorize samples having slight damage. The increased amount of light through the sample may also be beneficial for detecting damage that cannot be detected by an ordinary observer but may, nonetheless, be desirable to detect. For example, the visual ranking system generally does not distinguish very well between samples having the same damage level (for example, one of damage levels 1 to 5 as discussed below). However, the inspection apparatus of the present disclosure, with the proper set-up (including a sufficient amount of light, image capture device exposure, and/or image capture device gain) can distinguish between samples having slight differences in damage, e.g., between samples both having a visual ranking of 1. On the other hand, the amount of light can be adjusted so that damage which is not visible to the naked eye has a negligible contribution on the numerical result provided by the inspection apparatus. In the former case, the inspection apparatus can be made to mimic the visual ranking system so that the results will be in line with an ordinary observer's perceptions.

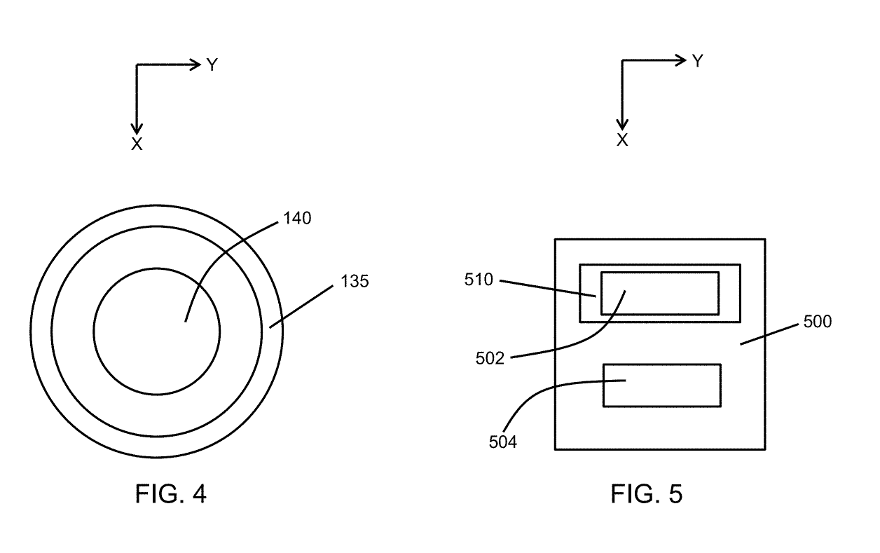

In some embodiments, ring light 135 may be beneficial when the sample is part of a device, for example an electronic device having a display, and the sample edges are not readily accessible. As shown in FIG. 1, ring light 135 may be disposed (in the Z-direction) above image capture device 140. Alternatively, not shown, ring light 135 may be disposed (in the Z-direction) below image capture device 140. In either case, as shown in FIG. 4, ring light 135 may be disposed so as to surround image capture device 140 so as to provide uniform illumination to the sample 200. For example, the ring light 135 may be a LumiTrax ring light, part CA-DRW10X (or CADRW20X) from Keyence, Itasca, Ill. In some situations, the ring light 135 may be beneficial in producing an environment more similar to a user's visual experience (i.e., light coming from above or around the user's vantage point) than does a line-light optically coupled to the edge of a sample. When using ring light 135, polarizers may be used on the image capture device 140 and/or on the ring light 135 itself to reduce specular reflection of these components off of the sample as such reflections can interfere with the analysis of the wear tracks by increasing the amount of light collected that is not due to the damaged area. The polarizers also reduce the overall intensity signal and, thus, it is preferable not to use them when possible, for example, where other measures can be taken to reduce the specular reflection off of the image capture device 140 and/or ring light 135.

Whether the light source includes one or more line-lights or ring lights, it beneficially produces white light. Beneficially, the intensity of the light may be adjusted to accommodate different sample types (having different light transmission levels, different materials, e.g., glass, plastic, ceramic, glass-ceramic), and/or different damage types, as well as for the sensitivity and/or gain of the image capture device 140, and the exposure time. For example, the light intensity may be adjusted to achieve high quality images and have sufficient signal and resolution to examine fine scratch damage. Appropriate light intensity may be determined by visually inspecting the images to select settings that produced images with a sufficient amount of signal for differentiation while still maintaining contrast.

The image capture device 140 may include a camera sensor that collects data regarding pixel intensity values (for example pixel intensity values ranging from 0 to 255 on an 8-bit grayscale, wherein 0 is black and 255 is white), one or more lenses, and controlling electronics. The data may be stored and/or processed in the image capture device 140 itself, or may be sent to and processed in separate controller 160. For example, a suitable camera sensor may be part number CA-HX500M or CAH2100M from Keyence, Itasca, Ill. The camera sensor may be used with one or more lenses to focus the light coming from the sample 200 onto the camera sensor. Although one image capture device 140 is shown, any suitable number of such devices may be included in the inspection apparatus 100. Additionally, although the image capture device 140 is shown as being located above (in the Z-direction) the sample 200, such need not be the case as long as the image capture device can accurately receive light intensity from the light source after having interacted with the sample 200. The image capture device 140 may have a field of vision so as to encompass the entire sample dimensions, or may have a field of vision more closely sized to the size of the intended damage track 210 plus a non-damaged ROI. The image capture device 140 is mounted to a base (not shown) so that it may be moved in X, Y, and Z-directions to align its field of view with the sample 200 on the sample holding stage 140.

The light-absorbing background material 150 may be any suitable material that absorbs light from the light source so as to improve the quality of the image captured by the image capture device 240. That is, it is desirable to minimize the amount of light reflected from the surroundings and back into the sample 200. For example, light may be reflected from support structures that mount the sample holding stage 130, or from the sample holding stage 130 itself. In some embodiments, the light-absorbing background material may include black flocking paper. Black flocking paper is particularly useful when the light source includes one or more line-lights 131, 132. The black flocking paper may be disposed in slot 124, so as to be on a side of the sample holding portion 122 as is the light source and/or image capture device 140. For example, the black flocking paper may be part number BFP1 from ThorLabs, having offices in Newton, N.J. Alternatively, or in addition, the light-absorbing background material 150 may include light-absorbing adhesive foil. The adhesive foil is particularly useful when the light source includes a ring light 135, and may be applied to the image-capture-device-facing surfaces of the sample holding stage 120 and background material below the sample 200. For example, the light-absorbing adhesive foil may be Metal Velvet™ available from Acktar Advanced Coatings, Kiryat-Gat, Israel. In other embodiments, a transparent sample may be index matched to a sheet of black ceramic or other suitable uniform black substrate in order to mimic how the transparent sample would be seen when incorporated into an electronic device, with the device in the off state. The black ceramic or other uniform black substrate could be held in the slot 124, so that the image capture device 140 views that substrate together with the transparent sample, and could be used in combination with other light-absorbing background material 150 to reduce undesired reflections.

The controller 160 may be a general or special purpose computing device including a central processing unit (CPU). The controller 160 may be connected to the light source and image capture device 140 to control them as well as to coordinate illumination of the sample 200 and image capture. Also, the controller 160 can store a damage metric scale, receive data from the image capture device 140, and process that data to find a damage level for any particular sample being inspected. The controller 160 may be a unit separate from the image capture device 140, or may be an integral part thereof. Additionally, in some embodiments, the controller may be connected to the mechanisms (not shown) that move the sample holding stage 120, light source, and/or image capture device 140, so as to control the positioning of the elements in relation to one another.

Embodiments and the functional operations described herein can be implemented in digital electronic circuitry, or in computer software, firmware, or hardware, including the structures disclosed in this specification and their structural equivalents, or in combinations of one or more of them. Embodiments described herein can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine readable storage substrate, a memory device, or a combination of one or more of them.

The term “processor” or “controller” can encompass all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), or tablet.

Computer readable media suitable for storing computer program instructions and data include all forms data memory including nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments described herein can be implemented on a computer having a display device, e.g., a CRT (cathode ray tube) or LCD (liquid crystal display) monitor, and the like for displaying information to the user and a keyboard and a pointing device, e.g., a mouse or a trackball, or a touch screen by which the user can provide input to the computer. Other kinds of devices can be used to provide for interaction with a user as well; for example, input from the user can be received in any form, including acoustic, speech, or tactile input.

Embodiments described herein can be implemented in a computing system that includes a back end component, e.g., as a data server, or that includes a middleware component, e.g., an application server, or that includes a front end component, e.g., a client computer having a graphical user interface or a Web browser through which a user can interact with implementations of the subject matter described herein, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Description of the Methodology

The inspection apparatus 100 illuminates the samples, and the damaged surface areas of the sample scatter some of the incident light. The intensity of the scatter is proportional to the amount of surface damage, enabling quantification and categorization. The proportionality may be linear, or may not be linear, but generally, as damage increases, the amount of light scattered therefrom increases. Accordingly, the inspection apparatus may be tailored to measure damage for a given sample set. Generally, the process of setting up an inspection apparatus to test for a particular damage type (for example abrasion wear damage, scratch) in a particular sample type (for example, bare glass, glass having a scratch-resistant and/or optical coating thereon, plastic) is as follows.

Initially, samples having the desired damage type are obtained. The samples may be obtained in a state in which the desired damage is already produced thereon, or undamaged samples may be obtained, and the desired damage is then produced thereon. Next, the samples are visually ranked by one or more ordinary observers (with a naked eye) from one extreme (for example, lowest damage) to another extreme (for example, highest damage), wherein the extremes bound the damage levels, and are called limit samples. A pairs comparison may be used to increase the accuracy of the visual observation and/or as a manner of confirming the performance of the inspection apparatus according to the human visual interpretation. A damage metric scale (which is a function of light intensity in a captured image) appropriate for the desired damage and sample types is loaded into, or selected from within, the controller 160. The extreme samples (for example, lowest and highest damage) and one from the middle of the damage distribution, each in turn are then put on a sample holding stage, illuminated with a light source, and an image thereof is captured with an initial set of hardware conditions (for example camera exposure or shutter speed, camera gain or sensitivity, and illumination intensity). The images are evaluated to determine whether light intensity distribution is visible in an image, and whether the damage metric scale produces a damage level appropriately corresponding to the visual ranking for that sample (for example, the damage level for the visually-ranked sample with the highest damage is the largest damage level, the damage level for the visually-ranked sample with the lowest damage is the smallest damage level, and the damage level for the visually-ranked sample with medium damage is between the largest and smallest damage levels. The hardware conditions are then adjusted, as necessary and in an iterative manner—for example image capture, determine whether light distribution from damage in samples is visible (for example, making sure that the signal to noise ratio is sufficiently large enough to be detected across damage levels), determine whether damage level appropriately corresponds to the visual ranking, and adjust hardware conditions—so that the full range of damage can be seen in the captured images, i.e., so that the damage on each of the extreme samples and the middle sample shows some light intensity distribution in the respective captured image, and that the correspondingly assigned damage levels are appropriate. After the hardware conditions are set for a desired sample type and damage type, any desired number of samples of that type may be sequentially evaluated by the inspection apparatus.

In alternative embodiments, variations in the above are possible. For example, if future samples are outside of the range of the initial limit samples, the procedure may be repeated to adjust the scale, if desired. Because the inspection apparatus is capable of saving images, the original images may be reprocessed according to the adjusted scale. For example, the scale may be changed from 1-5 to 1-100, or 1-50, or 1-200, or any desired and/or useful numerical range. Likewise, when saved images are available, the visual ranking may be performed using the saved images rather than original samples, through a process such as pairs comparison.

Because the hardware conditions may be adjusted, the inspection apparatus may be used to evaluate a variety of damage types across a variety of different sample types. For example, for sample sets in which there is slight damage over the range of interest, or for sample types that have low transparency, the illumination intensity can be increased, the camera gain can be increased, and/or the camera exposure can be increased. On the other hand, for example, for sample sets in which there is a significant amount of damage over the range of interest, or for sample types that have high transparency, the illumination intensity can be decreased, the camera gain can be decreased, and/or the camera exposure can be decreased. In such a manner, an appropriate level of the light intensity, camera gain, and/or camera exposure can be found to match the desired damage and sample type.

The above-described methodology can be used to set up the inspection apparatus to evaluate samples of different, but representative of the device-user-induced damage, damage tests according to the following examples. The main components of the measurement protocols include capturing an image, determining the location of the intended damage track based on identification of the sample edges, measuring the light intensity within ROIs (damage or non-damaged ROI) including calculating an average intensity value, the standard deviation of the intensity, and calculating a damage metric.

Wear Track Produced by a Plurality of Contact Abrasion Cycles

An electronic device may be subject to wear from repeated sliding contact from, for example, a user sliding his finger across the surface. One metric to evaluate a device's (or sample's) resistance to such wear (and to similar types of wear) is a Taber Abrasion Test.

The Taber Abrasion Test is performed using a Taber Linear Abraser (Model 5750, Taber Industries, North Tonawanda, N.Y., USA). The Taber Linear Abraser uses a horizontal arm that reciprocates in a linear motion. Attached to the end of the arm is a precision bearing spline shaft that creates a ‘free-floating’ test system and permits vertical movement. The test attachments are affixed to the bottom of the spline shaft and a weight support is mounted to the top. Abradants may range from cloth to sandpaper depending on the aggressiveness desired. As the horizontal arm strokes back and forth, the test system raises or lowers vertically as the test attachment follows the contours of the sample. Adjustable settings enable the user to select the speed, stroke length, and test load. The Taber Abrasion Test typically uses a CS-17 abradant (available from Taber) and undergoes multiple (for example, 10, 100, or 500) cycles. Unless otherwise noted, CS-17 abradant was used herein. The Taber Linear Abraser is used to put an intended damage track in a given location on a sample. After interaction with the Taber Linear Abraser, the intended damage track may or may not include actual damaged areas, depending upon the severity of the abrasion and the toughness of the sample.

The inspection apparatus described herein may then be used to evaluate the damage (or lack of damage) in the intended damage track as follows.

Light from the light source is directed toward the sample. Light scattered from the sample is then captured in an image by an image capture device. The region of the image corresponding to the location of the intended damage track is then analyzed. FIG. 5 schematically shows an image 500 captured by the image capture device. The image includes an area 510 corresponding to the intended damage track 210. An ROI 502 is selected within the area 510, and the mean light intensity thereof is measured on an 8 bit grayscale having values from 0 for black to 255 for white. To find the mean value, the value of each pixel in the ROI is determined, and then those values are used to calculate the mean value for the ROI as a whole. This same pixel-by-pixel evaluation is used for the damage metric calculations performed herein, unless noted otherwise. As used herein, unless otherwise noted, light intensity measurements are made on an 8 bit grayscale having values from 0 for black to 255 for white. However, the inspection apparatus can be used with different scales for light intensity, and the desired metric adjusted accordingly. Also, a higher bit depth image capture device may be used (for example, a 12-bit, or 16-bit) which may allow for more grayscale resolution.

The size of the ROI is not particularly important. However, the ROI is sized to be smaller than the area 510, but large enough to produce meaningful data. Also, to avoid noise induced at the edges of area 510, the ROI 502 may be centered within the area 510. Generally, for a user in this art, one would want to collect data from as large an ROI as possible, subject to other constraints. The ROI in this case is also dependent on camera and/or lens assembly specs (including pixel size, resolution, magnification) and could be experimentally determined for statistical validity (i.e. how many pixels should there be in the ROI to be representative of the damage?). One manner for doing so is to start with one pixel and slowly increase the size of the ROI, measuring the average light intensity for representative ROI's as the ROI increases in size. The size at which the average pixel intensity levels off is the minimum practical ROI.

An ROI 504 is then selected for the non-damaged portion of the sample. The ROI 504 has the same sized and shaped area as the ROI 502 but is outside of the area 510. The ROI 504 is the non-damaged ROI, and the mean intensity of that ROI 504 is then measured.

The abrasion damage metric for samples prepared with the Taber Abrasion Test is then calculated from the following equation (1):

abrasion damage metric=ln [maximum(mean intensity adjusted,1)] (1)

where: “ln” is natural log; mean intensity adjusted=mean light intensity in scratched ROI 502−mean light intensity in non-damaged ROI 504; the terminology “maximum (x,y)” means to take the greater of the two values x and y. Thus, in equation (1), the value of which the natural log is taken would be the greater value of either (i) the mean intensity adjusted or (ii) 1. This forces the metric to be a positive value by forcing the argument of the natural log to be at least 1.

Thus, the abrasion damage metric is continuous on a scale of zero to approximately 5.54 and adjusts for the pixel intensity of the non-damaged, background area. The value of the abrasion damage metric corresponds to the visual ranking damage levels. Accordingly, the value of the abrasion damage metric is assigned as the damage level of the sample. The current visual ranking scale stops at 5, though this is more a limitation of human perception (which can generally observe damage features having a size on the order of 100 to 200 microns) and the samples used (e.g. plastic samples may sustain much greater damage though were not included in this sample set) than a plateau in the amount of surface damage and the ability of the inspection apparatus to capture it.

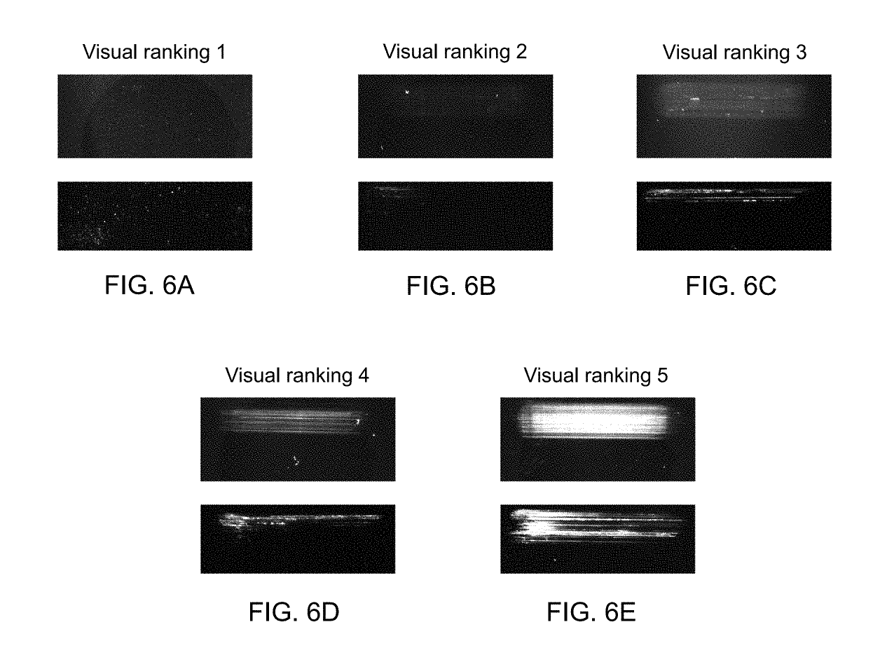

FIGS. 6A-E shows five different samples having visual rankings of damage level from 1 to 5, wherein the top image in each figure is for abrasion damage, and the bottom image in each figure is for scratch damage. The visual rankings are performed under typical viewing conditions, including ambient light in a conference room and daylight. The ranking scale used to visually rate samples is a 1 to 5 scale from low damage to high damage. General criteria corresponding to the damage levels are as follows with corresponding representative images of Damage Levels 1-5 in FIGS. 6A-E, respectively.

Damage Level 1: no visible damage

Damage Level 2: barely scratched, no significant change in haze

Damage Level 3: visible scratches at various angles, some change in haze

Damage Level 4: bothersome damage, heavy haze

Damage Level 5: heavy lateral cracks and chips, heavy haze (no longer transparent).

To confirm the accuracy of the abrasion damage metric, a pairs comparison visual inspection technique was used. The pairs comparison technique gives a continuous visual ranking which can be compared to the abrasion damage metric. In this technique images are displayed in pairs with 100 points (for example) to allocate between each pair of images. The person rating the images scores the left image based on the perceived difference in damage to the right image. For example, if the left image had no visible damage it would receive a score of zero or if the left and right images had the same damage then the left scratch would receive a score of 50. The scores for each pair are converted to ratios. Then for each sample the geometric average is taken of the ratios that contain that sample relative to the other samples resulting in a value for that sample on a continuous scale. The left image is given a score 0 (least damage) to 100 (most damage) relative to the image on the right. The comparison and scoring is done for all possible pairs of images. Multiple viewers may participate, in which case, the data for each individual pair of images is averaged over the number of viewers. To facilitate calculation, a score of 0 is counted as 1 and a score of 100 is counted as 99 to avoid division and multiplication by zero in the calculations. The resulting values are set forth in an n×n matrix, where n is the number of unique samples. The diagonal values are set to one because the same damage is not rated against itself. Next, each cell in the score matrix is divided by the opposite cell across the diagonal to form the ratio matrix. For example ratio matrix cell [5,4]=score[5,4]/score[4,5], and likewise ratio matrix cell [4,5]=score[4,5]/score[5,4]. Each column of the ratio matrix corresponds to a sample. The average ratio or geometric average of each column (sample) is taken. The result is the average pairs comparison ratio ranking for that sample.

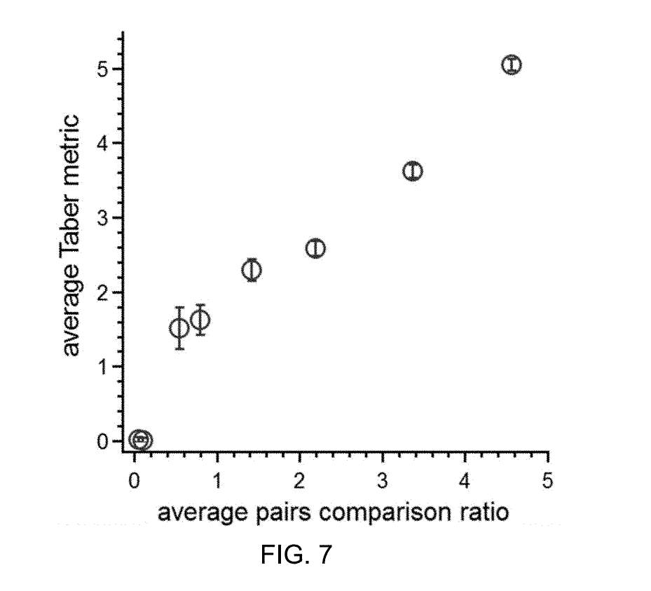

FIG. 7 shows the abrasion damage metric (on the y-axis) as a function of average pairs comparison ratio (on the x-axis for the same samples) across a spectrum of damage. Eight samples spanning the range of damage were clearly distinguished (wherein some of the samples had the same damage level), and as shown in FIG. 7 the abrasion damage metric corresponds to the visual ranking as determined by the visual pairs comparison ratio. The abrasion damage metric does put the samples in the order of lowest damage to highest damage, as per human visual interpretation, as is beneficial. Further, in this case, the relationship may appear to be somewhat linear, but such need not be the case.

Further, the accuracy of the inspection apparatus and abrasion damage metrics was evaluated, and found as follows. Two major sources of variation of interest are the reproducibility and repeatability. Reproducibility is the effect due to operator and the repeatability is known as residual variation. Push button standard deviation (leaving a sample on the sample holding stage, turning off the inspection apparatus, turning back on the inspection apparatus, and again measuring the sample−performed three times) is ≤0.023 abrasion damage metric units (average standard deviation across all samples is 0.010 abrasion damage metric units). The standard deviation due to repeatability and reproducibility is 0.14 abrasion damage metric units, corresponding to a 95% margin of error of 0.27 abrasion damage metric units, herein the standard deviations were calculated form a data set from nine samples, three operators, and four replicates. The standard deviations are calculated using the Taber Abrasion terms for repeatability and reproducibility in a random effects analysis of variance model used to analyze measurement systems or gauge repeatability and reproducibility.

Damage from Single Pass Contact Event

The Garnet Scratch Test is performed in a manner similar to that for the Taber Abrasion Test, except that garnet sandpaper having 150 grit is used as the abradant, and only a single stroke is used. This type of test simulates a one-time scratch event as may happen when a key or other sharp object comes into contact with a device or sample.

The inspection apparatus described herein may then be used to evaluate the damage (or lack of damage) in the intended damage track as follows.

Light from the light source is directed toward the sample. Light scattered from the sample is then captured in an image by an image capture device. The region of the image corresponding to the location of the intended damage track is then analyzed. FIG. 5 schematically shows an image 500 captured by the image capture device. The image includes an area 510 corresponding to the intended damage track 210. An ROI 502 (scratched ROI) is selected within a static area of the area 510.

The static area within the intended damage track, and corresponding area within area 510, is the initial area of contact the sandpaper makes on the sample before the arm starts the slide across the sample. However, after the sandpaper does move across the sample, scratches are produced in the static area, and it is the light intensity from these scratches in this area that are analyzed with the Garnet Scratch damage metric. Thus, the scratched ROI 502 for this test is sized to the static area, which corresponds to the size (area and shape) of the sandpaper abradant used for the test, and is the area on the sample where the sandpaper was initially set down. Because the scratches from the Garnet Scratch Test are produced with one pass, generally they are not uniform. Accordingly, to measure light intensity from the image, it is beneficial to use as large a rectangular ROI 502 as will fit within the static area. To measure the light intensity from the non-damage area, the ROI 504 for the non-damaged area is also the same size as the ROI 502 as was used to measure the scratched area. Again, the ROI 504 is outside of the intended damage track 510.

Again, mean light intensity is measured on an 8 bit grayscale having values from 0 for black to 255 for white. The light intensities in the ROIs are then analyzed and measured. To find the mean value of the non-damaged ROI 504, the value of each pixel in the ROI is determined, and then those values are used to calculate the mean value for the non-damaged ROI 504 as a whole. However, because of the nature of the Garnet Scratch Test, wherein only one pass of the abradant is made on the sample, not all of the pixels in the scratched ROI 502 are used in this damage metric. Instead, in order to more accurately distinguish scratches in a manner consistent with visual observation, a threshold value for light intensity is used in connection with the scratched ROI 502.

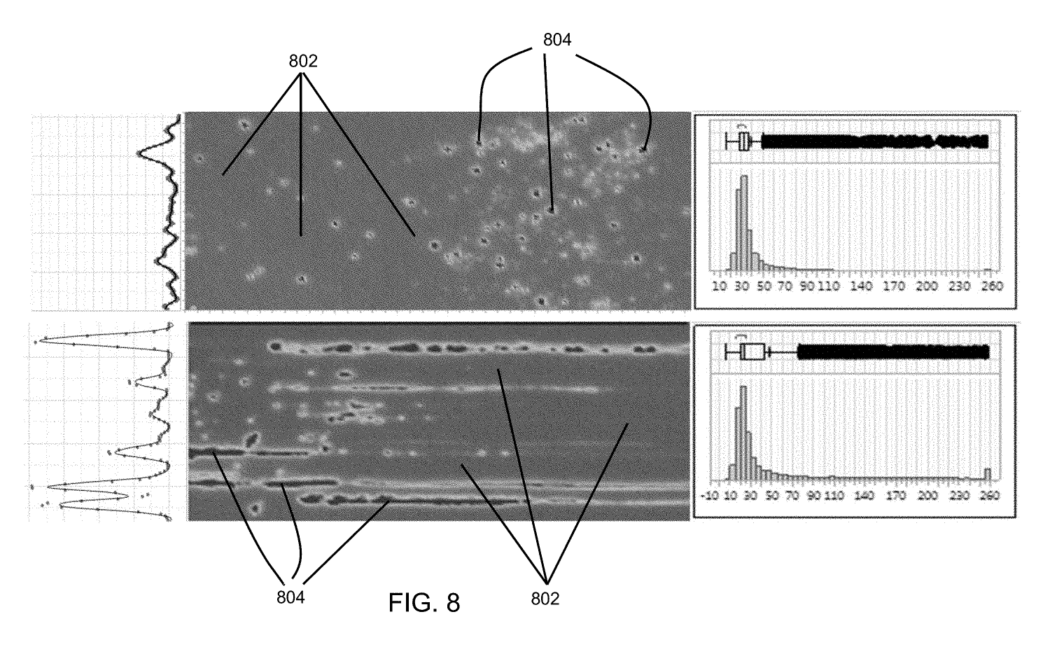

The reasoning, and one manner of setting the threshold value, will now be discussed in connection with FIG. 8. In the middle of FIG. 8, there are images of the static areas of two different samples, a top image and a bottom image. In the images, there is a distribution of light intensities from 0 to 255, wherein 0 corresponds to lighter regions of the image such as 802 having lesser intensity, and wherein 255 corresponds to darker regions of the image such as 804 having higher intensity. The profiles on the left-hand side of FIG. 8 show the pixel intensity from horizontal bands across each static area. On the right-hand side of FIG. 8, there are histograms of the pixel intensities shown in the middle images. As can be seen from the middle images, the bottom image has more visually noticeable damage consistent with scratch than does the top image. However, the mean of the intensity values for these images is similar, as shown by the histograms. Accordingly, using mean intensity values (as was done with the wear damage metric) will not be as accurate for the Garnet Scratch Test samples. Likewise, other measures of central tendency, such as median, will not be as accurate for the Garnet Scratch Test samples. More specifically, the large amount of regions 802 with lesser damage lower the means so that they are close together. Accordingly, the threshold is set to remove much of the regions 802. To include more of the regions 804 in the calculation, a threshold value is selected. One manner of selecting the threshold value is to look at the histograms. As is seen in the histograms of FIG. 8, the distributions are relatively similar until about 75 at which the bottom histogram has a more pronounced tail. Accordingly, for Garnet Scratch Test samples, it is beneficial to select a threshold value above the mean, and at a point sufficiently above the mean so as to provide a significant difference between samples. In the present example, a threshold value of 75 produced excellent results. Once a threshold value is selected, the scratch damage metric is calculated as follows in equation (2):

scratch damage metric=ln {maximum [(% pixels with a light intensity value of greater than a threshold value and that are in a scratched ROI)*((mean intensity of pixels with a light intensity of greater than the threshold value in the scratched ROI) (mean intensity of a non-damaged ROI)),1]} (2)

wherein: “ln” is natural log; the scratched ROI is a pixel area within a static area at the beginning of an intended damage track; the non-damaged ROI is outside the intended damage track; the threshold value is one that is above mean intensity in the scratched ROI and is chosen to filter out light from non-damaged regions that are both within the scratched ROI and within the intended damage track; to calculate the % pixels having a light intensity value of greater than the threshold value, and the mean intensity of those pixels, only consecutive pixels together having a predetermined length or more are utilized, wherein the predetermined length extends in the direction of the longitudinal axis of the intended damage track and is set to filter out false positive values from contamination (for example, the predetermined length may be that of 5 pixels of a size corresponding to that of the image capture device examples described herein); and the terminology “maximum (x,y)” again means to take the greater of the two values x and y. Thus, in equation (2), the value of which the natural log is taken would be the greater value of either (i) (% pixels with a light intensity value of greater than a threshold value and that are in a scratched ROI)*((mean intensity of pixels with a light intensity of greater than the threshold value in the scratched ROI)−(mean intensity of a non-damaged ROI)) or (ii) 1. This forces the metric to be a positive value by forcing the argument of the natural log to be at least 1.

Thus, similarly to the abrasion damage metric, the scratch damage metric is continuous on a scale of zero to approximately 5.54 and adjusts for the pixel intensity of the non-damaged, background area. The value of the scratch damage metric corresponds to the visual ranking damage levels. Accordingly, the value of the scratch damage metric is assigned as the damage level of the sample. The visual ranking scale is the same as described above with respect to the Taber Abrasion Test samples, and suffers the same limitations.

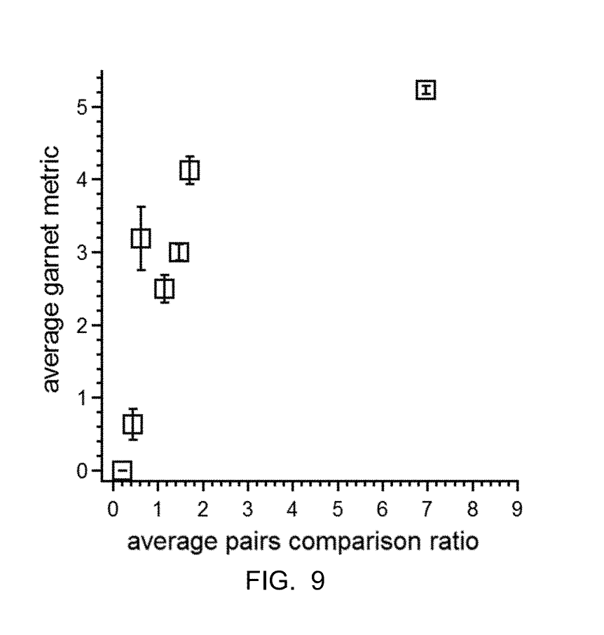

To confirm the accuracy of the scratch damage metric, a pairs comparison visual inspection technique was used, again as described above in connection with the Taber Abrasion Test samples. FIG. 9 shows the scratch damage metric (on the y-axis) as a function of average pairs comparison ratio (on the x-axis for the same samples) across a spectrum of damage. Seven samples spanning the range of damage (low to high—wherein more than one sample was representative of a particular damage level, except for damage level 5 of which there was one sample) were clearly distinguished, and as shown in FIG. 9 the scratch damage metric (average garnet metric) corresponds to the visual ranking as determined by the visual average pairs comparison ratio. In the case of FIG. 9, the pairs comparison does not necessarily have a linear relationship with the metric or with visual rankings (which may be the case for other metrics also); however the metric still does put the samples in the order of lowest damage to highest damage, as per human visual interpretation, as is beneficial.

The push button standard deviation for samples measured with the scratch damage metric is ≤0.013 scratch damage metric units (average standard deviation across samples is 0.003 scratch damage units). Repeatability and reproducibility standard deviation is 0.13 scratch damage metric units, corresponding to a 95% margin of error of 0.26 scratch damage metric units (wherein the standard deviations were calculated using data from twelve garnet-sandpaper-scratched samples, three operators, and three replicates. Again, similar to the case for Taber Abrasion, the standard deviations are calculated using the Garnet Scratch terms for repeatability and reproducibility in a random effects analysis of variance model used to analyze measurement systems or gauge repeatability and reproducibility studies.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, inward, outward—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

It will be apparent to those skilled in the art that various modifications and variations can be made to the present disclosure without departing from the spirit and scope of the disclosure. Thus, it is intended that the present disclosure cover such modifications and variations provided they come within the scope of the appended claims and their equivalents.

For example, when the intended damage track is intentionally produced, the non-damaged ROI is well defined (as is the case for both the abrasion metric and the scratch metric, and as would be expected for such a case when the damage is intentionally produced). However, when the damage is not intentionally produced, the non-damaged ROI may not be so well defined. In such a case, the principles of the present disclosure may still be used with some modification to the manner in which the measurements for the non-damaged ROI is determined. For example, in the case of field return devices or tumble test samples damage may cover the entire surface of the sample. In such cases a value for the “non-scratch ROI” may be determined by using a threshold over the entire field of view of the image capture device. Alternatively, a second undamaged sample (of similar type as the damaged sample, for example, if a particular manufacturer's tablet was being tested or field-returned, an undamaged tablet of the same model from the same manufacturer) could be used as a proxy area for measuring characteristics of a non-damaged ROI. Alternatively, in a tumble test, for example, a portion of the sample may be masked off to prevent damage, e.g. half of the sample is taped, which masked area could be unmasked and then used to make appropriate measurements for characteristics of a non-damaged ROI.

What is claimed is:

1. An inspection apparatus comprising:
a light source;
a sample holding stage;
an image capture device, positioned to receive light from the light source after the light has interacted with a sample on the sample holding stage;
a damage metric comprising two or more damage levels, wherein the damage metric is a function of light in a test image and correlates to visual observation, wherein the test image comprises test light from a test light source after the test light has interacted with a test sample.

2. The apparatus of claim 1, wherein the light source is a ring light source positioned on the same side of the sample holding stage as is the image capture device.

3. The apparatus of claim 1, wherein the light source is a first line-light disposed adjacent to the sample holding stage.

4. The apparatus of claim 3, further comprising a second line-light disposed adjacent to the sample stage on a side of the sample stage opposite the first line-light.

5. The apparatus of claim 1, further comprising a sample holding portion in the sample holding stage, and a light-absorbing background material, wherein the light-absorbing background material is disposed on a side of the sample holding portion that is opposite that on which the image capture device is located.

6. The apparatus of claim 1, wherein the light-absorbing background material is black flocking and the light source is an line-light.

7. The apparatus of claim 1, wherein the light-absorbing background material is light-absorbing adhesive foil, and the light source is a ring light source.

8. The apparatus of claim 5, wherein the light-absorbing background material is disposed on the sample holding stage.

9. The apparatus of claim 1, wherein the damage metric is
ln [maximum(mean intensity adjusted,1)], wherein
mean intensity adjusted=mean intensity in a scratched ROI−mean intensity in a non-damaged area, wherein the scratched ROI is a pixel area centered within an intended damage track, and the non-damaged area is outside of the intended damage track.

10. The apparatus of claim 9, further comprising a sample disposed on the sample stage, wherein the intended damage track comprises a wear track produced by a plurality of contact abrasion cycles.

11. The apparatus of claim 9, wherein when a calibration sample is measured three times without moving the calibration sample, the three measured values of damage metric have a standard deviation of 0.023, wherein the calibration sample comprises glass abraded for 500 cycles with a Taber Linear Abraser having CS-17 abradant under a load of 350 g.

12. The apparatus of claim 1, wherein the damage metric is
ln {maximum [(% pixels with a light intensity value of greater than a threshold value and that are in a scratched ROI)*((mean intensity of pixels with a light intensity of greater than the threshold value in the scratched ROI)−(mean intensity of a non-damaged ROI)), 1]}, wherein the scratched ROI is a pixel area within a static area at the beginning of an intended damage track, the non-damaged ROI is outside the intended damage track, and wherein the threshold value is one that is above mean intensity in the scratched ROI and is chosen to filter out light from non-damaged regions that are both within the scratched ROI and within the intended damage track.

13. The apparatus of claim 12, further comprising a sample disposed on the sample stage, wherein the intended damage track consists of a scratch produced by a single pass contact event.

14. The apparatus of claim 12, wherein to calculate the % pixels having a light intensity value of greater than the threshold value, and the mean intensity of those pixels, only consecutive pixels together having a predetermined length or more are utilized, wherein the predetermined length extends in the direction of the longitudinal axis of the intended damage track and is set to filter out false positive values from contamination.

15. The apparatus of claim 12, wherein when twelve samples are measured by each of three different operators, each at four different times, the data set of 144 measured values of damage metric has a standard deviation of ≤0.13.

16. The apparatus of claim 9, wherein the intended damage track is located on a surface of the sample.

17. A method of calibrating an inspection apparatus for a desired damage type comprising:
obtaining samples having the highest damage and the lowest damage from a set of visually ranked samples having the desired damage type;
measuring damage metric values for the samples with the inspection apparatus of any one of claims 1-16, using a selected image capture device exposure, image capture device gain, and/or illumination intensity of the light source;
comparing the measured damage metric values with the visual rankings from corresponding samples;
adjusting at least one of image capture device exposure, image capture device gain, and illumination intensity of the light source; and
repeating the comparing and adjusting so that the measured damage metric values correspond with the visual rankings of corresponding samples.

18. The method of claim 17, further comprising:
performing a pairs comparison of a set of calibration samples by visual ranking to assign damage levels to each calibration sample;
measuring damage metric values for the set of calibration samples; and
comparing the visually assigned damage levels with the damage metric values for corresponding calibration samples.

19. An inspection method comprising:
directing light from a light source toward a sample;
capturing with an image capture device an image of light from the light source after the light has interacted with the sample;
analyzing the captured image according to a damage metric comprising two or more damage levels, wherein the damage metric is a function of light in a test image and correlates to visual observation, wherein the test image comprises test light from a test light source after the test light has interacted with the test sample,
assigning a damage level to the captured image.

20. The method of claim 19, wherein directing light comprises directing light from a ring light source positioned on the same side of the sample as is the image capture.

21. The method of claim 19, wherein the directing comprises directing light from a first line-light optically coupled to an edge of the sample.

22. The method of claim 19, wherein the directing further comprises directing light from a second line-light optically coupled to a sample edge on a side of the sample opposite the first line-light.

23. The method of claim 21, wherein the sample comprises an intended damage track extending along a first axis, the first line-light extends along a second axis, and the second line-light extends along a third axis, and further wherein the first axis is substantially parallel to the second and/or third axis.

24. The method of claim 19, further comprising absorbing light with a background material, wherein the background material is disposed on a side of the sample that is opposite that on which the image capture is performed.

25. The method of claim 19, wherein the background material is black flocking and the light source is a line-light.

26. The method of claim 19, wherein the light-absorbing background material is light-absorbing adhesive foil, and the light source is a ring light source.

27. The method of claim 19, wherein the damage metric is
ln [maximum(mean intensity adjusted,1)], wherein
mean intensity adjusted=mean intensity in a scratched ROI−mean intensity in a non-damaged ROI, wherein the scratched ROI is a pixel area centered within an intended damage track, and the non-damaged ROI is outside the intended damage track.

28. The method of claim 27, wherein the intended damage track comprises a wear track produced by a plurality of contact abrasion cycles.

29. The method of claim 19, wherein the damage metric is
ln {maximum [(% pixels with a light intensity value of greater than a threshold value and that are in a scratched ROI)*((mean intensity of pixels with a light intensity value of greater than the threshold value and that are in the scratched ROI) (mean intensity of a non-damaged ROI)),1]}, wherein the scratched ROI is a pixel area within a static area at the beginning of an intended damage track, the non-damaged ROI is outside the intended damage track, and wherein the threshold value is one that is above mean intensity in the scratched ROI and is chosen to filter out light from non-damaged regions that are both within the scratched ROI and within the intended damage track.

30. The method of claim 29, wherein the intended damage track consists of a scratch produced by a single pass contact event.

31. The method of claim 29, wherein to calculate the % pixels with a light intensity value of greater than the threshold value, and the mean intensity of those pixels, only consecutive pixels together having a predetermined length or more are utilized, wherein the predetermined length extends in the direction of the longitudinal axis of the intended damage track and is set to filter out false positive values from contamination.

32. The method of claim 27, wherein the intended damage track is located on a surface of the sample.
